(19) United States
(12) Patent Application Publication
(10) Pub. No.: US 2005/0029006 A1
(43) Pub. Date: Feb. 10, 2005

(54) Signal transmission cable terminal device and data transmission method using signal transmission cable

(75) Inventors: Hirokazu Takahashi, Tochigi (JP); Atsushi Tsujino, Tochigi (JP); Kiyonori Yokoi, Tochigi (JP); Hiroyuki Ootsuka, Tochigi (JP)

Correspondence Address: Smith Gambrell & Russell, 1850 M Street NW, Suite 800, Washington, DC, 20036, US

(73) Assignee: Sumitomo Electric Industries Ltd.

(21) Appl. No.: 10/493,663

(22) PCT Filed: Jul. 9, 2002
(86) PCT No.: PCT/JP02/06948

(30) Foreign Application Priority Data
Oct. 25, 2001 (JP) 2001-328292

(51) Int. Cl. H01B 7/18

(52) U.S. Cl. 174/102 R; 174/113 R

(57) ABSTRACT

It is intended to provide a high-speed differential signal cable having a small diameter and high strength. A 4-conductor cable includes four insulation-coated insulated wires (center conductors) bundled together, and a wire mesh and an insulating sheath which cover a periphery thereof, and this cable is characterized in that a conductor size of center conductor wires is thinned so as to satisfy a specified value of attenuation with a cable length of 2.5 m, and also twisted pair wires are replaced by a quad-structure wire, so that the outer diameter is not larger than 3 mm.

### TECHNICAL FIELD

This invention relates to a signal transmission cable, a terminal apparatus and a data transmission method using a signal transmission cable, and more particularly to the structure of a high-speed differential signal cable with small-diameter and high-strength characteristics used in the case where the supply of electric power is not needed in a high-speed serial interface (called IEEE1394) used to connect a computer to its peripheral device.

### BACKGROUND ART

In IEEE1394, there have been used “IEEE1394-1995 Standard” as shown in FIG. 7 in which the supply of electric power is conducted and “Standard for a High Performance Serial Bus (Amendment 1) (hereinafter referred to as “Amendment 1 of the IEEE1394-1395 Standard”) as shown in FIG. 8 in which the supply of electric power is not conducted. This is based on the assumption that the maximum cable length of IEEE1394 is 4.5 m.

As shown in FIG. 8, a cable structure of this Amendment 1 is formed by further twisting two twisted pair wires 102 together, by covering these wires with an insulating tape 111, and further by covering it with an outer shielding member (114) comprising a wire mesh 113. Its outer surface is covered with an insulating sheath 115.

Here, the twisted pair wire 102 is formed by twisting two insulated wires 106 (each formed by covering a center conductor (consisting of a bundle of 7 center conductor wires 104) with an insulating material 107) together, and then by covering it with an outer shielding member 110 comprising a metallic tape 108 and a wire mesh 109.

With respect to the structure this far, the two are similar to each other as shown in FIGS. 7 and 8. However, In “the IEEE1394-1995 Standard” in which the supply of power is conducted, two additional insulated wires 106 (each formed by covering a center conductor (consisting of another bundle of 7 center conductor wires 104) with an insulating material 107′), together with the twisted pair wires 102, are twisted together, and it is covered with the outer shielding member 114. Except that the two insulated wires are thus added and that the outer shielding member 114, consisting of a metallic tape 112 and the wire mesh 113, is formed on the outside of the insulating tape 111, “Amendment 1 of the IEEE1394a-1395 Standard” (shown in FIG. 8) in which the supply of power is not conducted and “IEEE1394-1995 Standard” (shown in FIG. 7) in which the supply of power is conducted are formed similarly with each other.

In “Amendment 1 of the IEEE1394a-1395 Standard” (which is one of the above two) as shown in FIG. 8 in which the supply of power is not conducted, it has been recommended to use a conductor size of AWG 30 to AWG 28 for copper wires serving as the center conductor forming the insulated wire 106, in order to effect the propagation over a maximum cable length of 4.5 m. However, the actually-used cable lengths are mostly not larger than 2.5 mm.

Incidentally, factors in the determination of the cable diameter include the specification of mechanical strength and attenuation. However, when the individual constituent elements were merely reduced in size or diameter so as to reduce the cable diameter, there was encountered a problem that the cable, sufficiently satisfactory in both mechanical strength and signal propagation performance, was not obtained.

However, if it is premised that the cable length is not larger than 2.5 m, a margin for the specified value of the attenuation is large when the conductor size of the center copper wires is AWG 30 to AWG 28. And besides, when a twisted pair wire structure as in the conventional construction was adopted with this conductor size, there was encountered a problem that the finish outer shape of the cable was as thick as about 4.8 mm.

### DISCLOSURE OF THE INVENTION

This invention has been made in view of the above circumstances, and an object of the invention is to provide a high-speed differential signal cable having a small diameter and high strength.

According to the present invention, there is provided a 4-conductor cable comprising four insulated wires (each comprising a center conductor having an insulating coating) bundled together to form a quad-structure, and a wire mesh and an insulating sheath which cover a periphery of the quad-structure wire, characterized in that in order to satisfy a specified value of attenuation with a cable length of 2.5 m, a conductor size of each of the center conductors forming the quad-structure wire is reduced, for example, from (AWG 30 to AWG 28) to AWG 36, and also twisted pair wires are replaced by the quad-structure wire, so that the outer diameter is not larger than 0.3 mm.

In the present invention, the cable length is not larger than 2.5 m, and also the center conductors and the wire mesh are adjusted within this cable length range, and a control is conducted so as to satisfy the mechanical strength and the attenuation amount, and by doing so, a broadband performance equal to that of the current products can be secured while greatly reducing the outer diameter.

Namely, according to a first aspect of the present invention, there is provided a signal transmission cable characterized in that the cable comprises a quad-structure wire formed by bundling four center conductors, each having an insulating coating, into a quad-structure; a wire mesh covering a periphery of the quad-structure wire; and an insulating sheath further covering an outer surface of the wire mesh; and the cable is so constructed that its outer diameter is not larger than 3 mm.

With this construction, the finish outer shape of the cable can be much thinned. With respect to a signal wire in “Amendment 1 of the IEEE1394a-1395 Standard”, a recommended value of the center copper wires has been proposed in order to effect the propagation over the maximum cable length of “4.5 m”. However, the actually-used cable lengths are mostly “not larger than 2.5 mm”, and therefore the cable is designed to satisfy the specified value of the attenuation with the cable length of “not larger than 2.5 m”. By providing the quad-structure, the outer diameter can be made smaller as compared with a twisted pair structure. However, the quad-structure has a problem that crosstalk characteristics are worsened. And besides, the small-diameter design invites a problem that the cross-sectional area of each center conductor is reduced, so that the mechanical strength is inferior. Here, usually, the outside of the quad-structure wire is fixed by an insulating tape, and if necessary, its outside is protected by a metallic tape, and further its outside is covered with a wire mesh.

With these in view, the present invention is aimed at reducing the outer diameter to such a degree that stresses are less liable to act on the quad-structure wire and that satisfactory crosstalk characteristics are obtained.

Namely, in the present invention, the quad-structure and the wire mesh are adjusted so that the crosstalk characteristics can be satisfied, and also a high resistance to an external force can be obtained, and further the overall outer diameter can be reduced as much as possible while maintaining a good balance of the quad-structure.

Incidentally, when the conductor size of the wire mesh is reduced, there arises a drawback that the mechanical breaking force becomes low. In IEEE1394, electrical connectors are connected to opposite ends of a signal cable, respectively. These electrical connectors are classified into a 4-pole type and a 6-pole type. The mechanical breaking force, produced when clamping the signal cable to these electrical connectors, is specified in “Amendment 1 of IEEE1394A-1395 Standard”.

According to this standard, it is 49N for the 4-pole type, and it is 98N for the 6-pole type.

In the electrical connector of IEEE1394, usually, a length of several centimeters is cut off from an insulating sheath of a signal cable, and an outer shielding wire mesh is turned back on the insulating sheath, and the connector is clamped to this turned-back portion. Therefore, a force first acts on the outer shielding wire mesh and the insulating sheath. Unless the specified value of the mechanical breaking force of the wire mesh and insulating sheath exceeds the mechanical breaking force, the center conductors are elongated, so that there arises a problem that the attenuation is worsened.

The mechanical breaking force of the insulating sheath is less than 1/10 of the mechanical breaking force of the outer shielding wire mesh per cross-sectional area, and therefore the specified mechanical breaking force need to be satisfied by the mechanical breaking force of the outer shielding wire mesh.

Therefore, for example, a metallic wire, such as a tinned copper alloy wire, having a mechanical breaking force of not smaller than 400 MPa and an electrical conductivity of not smaller than 50% (preferably not smaller than 75%) is used to form the wire mesh although tinned copper alloy wire or tinned soft copper wire can be used as the material for the wire mesh. By doing so, the specified value of the mechanical breaking force, produced when clamping each electrical connector to the signal cable, can be satisfied. Here, the electrical conductivity means the electrical conductivity of the copper alloy wire after it is tinned.

Reference is made to the construction of the wire mesh, and in the case where the wire mesh has the same number of carriers and the same number of wirers per carrier, a conductor resistance of the wire mesh increases when the pitch is short, so that the attenuation of the signal cable is worsened. And, when the laying amount of the metallic wires of the wire mesh is small, a tensile stress acts on the wire mesh, and stresses on the center conductors (bundle) are reduced, and therefore it is preferred to determine the pitch so that the braiding angle of the wire mesh can be not smaller than 60 degrees.

Preferably, the signal transmission cable is characterized in that it has a length of not larger than 2.5 m and that the cable is so formed that the breaking strength of the connection portion can satisfy Amendment 1 of IEEE1394a-1395 Standard.

With this construction of the invention, the conductor size of each center conductor is reduced, and also the quad-structure is adopted, and by doing so, the finish outer shape of the cable can be thinned while satisfying the standard of the signal wire of “IEEE1394a-1395 Standard”. As a result, there can be achieved the cable which has a small bend radius, and is excellent in mechanical strength and handling ability.

Preferably, the cable is characterized in that the metallic wire, used to form the wire mesh, is made of a copper alloy.

With this construction, the wire mesh has a high electrical conductivity, and a sufficiently small elongation percentage, and will not break the quad-structure wire by a pulling force.

Preferably, the cable is characterized in that the metallic wire, used to form the wire mesh, is a steel copper wire.

With this construction, the wire mesh has a high electrical conductivity, and a sufficiently small elongation percentage, and will not break the quad-structure wire by a pulling force.

Preferably, the cable is characterized in that the metallic wire, used to form the wire mesh, has a tensile breaking force of not smaller than 400 MPa and an electrical conductivity of not smaller than 50%.

With this construction, the specified value of the mechanical breaking force, produced when clamping each electrical connector to the signal cable, can be satisfied.

Preferably, the cable is characterized in that the metallic wire, used to form the wire mesh, has an elongation percentage of not larger than 10%.

With this construction, the wire mesh is formed by the use of the metallic wire having the elongation percentage of not larger than 10%, and therefore the quad-structure wire is protected by the wire mesh even upon application of a pulling force, and will not be damaged.

Preferably, the cable is characterized in that each of the center conductor wires is a copper wire having an outer diameter of not larger than 0.2 mm.

With this construction, even when four center conductors, each including seven center conductor wires covered with an insulating coating, are formed into a quad-structure, the outer diameter can be made not larger than 3 mm.

Preferably, the wire mesh is so constructed that the braiding angle is not smaller than 60 degrees.

With this construction in which the braiding angle is not smaller than 60 degrees, a stress due to a tensile stress acts on the wire mesh, and therefore the quad-structure wire (and hence the center conductor wires) is less liable to be broken by the stress.

Preferably, the cable is characterized in that the twist pitch at which the insulation-coated center conductors are twisted together to form the quad-structure wire is not larger than 30 times larger than the pitch diameter.

With this construction, the balance of the four center conductors, forming the quad-structure, is made uniform, so that the crosstalk characteristics can be enhanced. Preferably, the cable is characterized in that the twist pitch of the wire mesh is not larger than 30 times larger than the pitch diameter.

With this construction, the electrical conductivity is enhanced, and also stresses on the quad-structure wire are reduced, and from these two aspects, the more suitable regulation can be conducted, and there can be provided the signal transmission cable of high reliability.

Preferably, the cable is characterized in that the center conductor wires are made of the same material as the metallic wire forming the wire mesh.

With this construction, the two are equal in thermal expansion coefficient to each other, and therefore are less liable to undergo stresses due to a temperature change, and therefore there can be provided the more reliable cable.

Preferably, the cable is characterized in that an elongation percentage of the center conductor wires is not smaller than an elongation percentage of the metallic wire forming the wire mesh.

With this construction, the center conductors, forming the quad-structure wire, are less liable to undergo stresses upon elongation of the wire mesh.

Preferably, the cable is characterized in that the material of the metallic wire, forming the wire mesh, is so formed as not to exceed the elongation of the center conductor wires.

With this construction, there is eliminated a disadvantage that the center conductor wires are pulled to be broken and cut as a result of elongation of the wire mesh.

Preferably, the cable is characterized in that the twist pitch of the wire mesh is so adjusted that the wire mesh will not exceed the elongation of the quad-structure wire.

With this construction, there is eliminated a disadvantage that the quad-structure wire is pulled to be broken and cut as a result of elongation of the wire mesh.

The cable is characterized in that the material, wire diameter and twist pitch of the wire mesh are so selected that the wire mesh will not exceed the elongation of the quad-structure wire.

With this construction, there is eliminated a disadvantage that the quad-structure wire is pulled to be broken and cut as a result of elongation of the wire mesh.

Preferably, the cable is characterized in that the wire mesh is formed of a copper alloy wire having a wire diameter of 0.04 to 0.12 mm.

In order to maintain the above elongation, it is preferred that the wire diameter be in this range. When the outer diameter is smaller than the wire diameter of 0.04 mm, the tensile strength is small, and the wire mesh itself is liable to be broken, and an electrical resistance value increases. On the other hand, when the wire diameter of the metallic wire (such as a tin-contained copper alloy wire), forming the wire mesh, exceeds 0.12 mm, there are encountered problems that the outer diameter increases and that the flexibility is inferior.

More preferably, the cable is characterized in that the wire diameter of the wire mesh is in the range of between 0.05 mm and 0.08 mm.

In order to maintain the above elongation, it is more preferred that the wire diameter be in this range.

Preferably, the cable is characterized in that the twist pitch of the wire mesh is 0.1 to 0.8 times larger than the twist pitch of the center conductors forming the quad-structure wire.

With this construction, there is eliminated a disadvantage that the quad-structure wire is pulled to be broken and cut as a result of elongation of the wire mesh. And besides, this wire mesh need to have a low resistance since it must have the function of a collective shielding conductor, and therefore the wire mesh need to be a conductor of high electrical conductivity. Therefore, this twist pitch need to be made as long as 0.1 times larger than the twist pitch of the quad-structure wire so as to prevent the laying ratio from increasing.

And, in order to reduce the attenuation amount, it is necessary to increase the pitch of twisting of the four center conductors, forming the quad-structure wire, thereby preventing the laying amount from increasing. However, when the braiding pitch of the wire mesh is more than 0.8 times larger than the twist pitch of the quad-structure wire, a balance of the four-twist structure is liable to be lost, and impedance and crosstalk characteristics are unstable. And besides, when the pitch of the wire mesh is increased, the laying amount is reduced, so that there is encountered a problem that stresses are liable to act on the center conductors.

Preferably, the signal transmission cable is characterized in that this cable has a connector provided at at least one end thereof, and a strength of the connector is not smaller than 49N for a 4-pole structure, and is not smaller than 98N for a 6-pole structure.

With this construction, almost the same broadband performance as obtained in a transmission method, using the current products, can be secured, and at the same time the occupied area can be reduced by the smaller-diameter design, the high mechanical strength and high flexing properties.

According to a second aspect of the present invention, there is provided a terminal apparatus in a computer system comprising a computer terminal and peripheral devices, characterized in that an interface between the computer terminal and the peripheral device or an interface between the peripheral devices is formed by a signal transmission cable comprising a quad-structure wire formed by bundling four center conductors, each having an insulating coating, into a quad-structure, a wire mesh covering a periphery of the quad-structure wire, and an insulating sheath further covering an outer surface of the wire mesh, and the cable is so constructed that its outer diameter is not larger than 3 mm.

Here, also, usually, the outside of the quad-structure wire is fixed by an insulating tape or is protected by a metallic tape, and its outside is covered with the wire mesh.

According to a third aspect of the invention, there is provided a data transmission method characterized in that a signal transmission cable as defined in any one of the above paragraphs is installed between a computer terminal and a peripheral device or between peripheral devices to make a connection therebetween.

In this transmission method, almost the same broadband performance as obtained in a transmission method, using the current products, can be secured, and at the same time the occupied area can be reduced by the smaller-diameter design, the high mechanical strength and high flexing properties.

### BRIEF DESCRIPTION OF THE DRAWINGS

FIG. 1 is a cross-sectional, explanatory view showing a first embodiment of a signal transmission cable of the present invention.

FIG. 2 is an explanatory view showing a wire mesh of the first embodiment of the signal transmission cable of the invention.

FIG. 3 is a cross-sectional, explanatory view showing the first embodiment of the signal transmission cable of the invention.

FIG. 4 is an explanatory view showing an example of use of the first embodiment of the signal transmission cable of the present invention.

FIG. 5 is a view showing a measuring apparatus for measuring a tensile strength of the first embodiment of the signal transmission cable of the present invention.

FIG. 6 is a cross-sectional, explanatory view showing a second embodiment of a signal transmission cable of the present invention.

FIG. 7 is a cross-sectional, explanatory view showing a conventional signal transmission cable.

FIG. 8 is a cross-sectional, explanatory view showing a conventional signal transmission cable.

In the drawings, 1 denotes a signal transmission cable, 3 a quad-structure wire, 4 a center conductor wire, 6 an insulated wire, 7 an insulating material, 11 an insulating tape, 12 a metallic tape, 13 a wire mesh, 15 an insulating sheath, 41 a computer, 42 a first terminal, 43 a second terminal, 44 a third terminal, 51 a first chucker, 52 a second chucker, 101 a signal transmission cable, 102 a twisted pair wire, 104 a center conductor wire, 106 an insulated wire, 107 an insulating material, 108 a metallic tape, 109 a wire mesh, 110 an outer shielding member of the twisted pair wire, 111 an insulating tape, 112 a metallic tape, 113 a wire mesh, 114 an outer shielding member, and 115 an insulating sheath.

### BEST MODE FOR CARRYING OUT THE INVENTION

An embodiment of the present invention will now be described in detail with reference to the drawings.

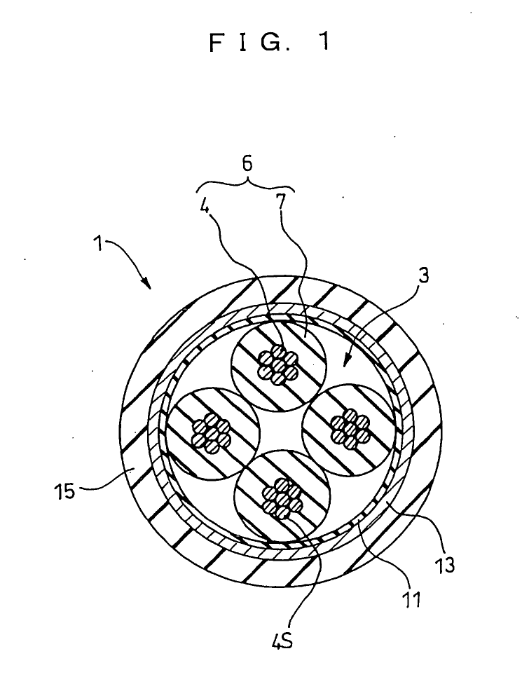

As shown in FIG. 1, the first embodiment of a signal transmission cable 1 of the present invention is formed by twisting four insulated wires 6 (each comprising an insulation-coated center conductor) together to form a quad-structure wire 3, by covering its outer surface with an insulating tape 11 or a metallic tape, and further by covering it with an outer shielding member comprising a wire mesh 13, and an outer diameter of this cable is not larger than 3 mm. Here, the center conductor is formed by twisting 7 center conductor wires 4 together. Then, it is covered at its outer surface with an insulating coating layer 7 composed of a fluororesin, polyethylene, foamed polyethylene, thereby forming the insulated wire 6. In order that this signal transmission cable 1 can satisfy specified values of attenuation and mechanical strength with a cable length of 2.5 m, this signal transmission cable is characterized in that a conductor diameter of the center conductor, forming the insulated wire 6, is reduced into not larger than 0.2 mm, that twisted pair wires are replaced by the quad-structure wire 3, and that the outer diameter is not larger than 3 mm.

Namely, in this signal transmission cable, the seven center conductor wires 4 (each consisting of a single copper wire coated at its outer surface with a tinning layer, and having a wire diameter of 0.047 to 0.064 mm) are twisted together at a twist pitch of not smaller than 1.5 mm, and the insulating coating layer 7, composed of a fluororesin, polyethylene, foamed polyethylene having a thickness of not larger than 0.13 mm, an underwater capacitance of not larger than 150 pF/m and a dielectric constant of 1.7 to 2.3, is coated on the center conductor, thereby forming the insulated wire 6, and the four insulated wires thus formed are bundled together into a quad-structure, thereby forming the quad-structure wire 3. Then, this quad-structure wire 3 is covered at its outer surface with the insulating tape 11, and further it is covered at its outer surface with the wire mesh 13 of copper so formed as not to exceed the elongation of the quad-structure wire 3 and hence the elongation of the center conductor wires 4, and further it is covered at its outer surface with an insulating sheath 15.

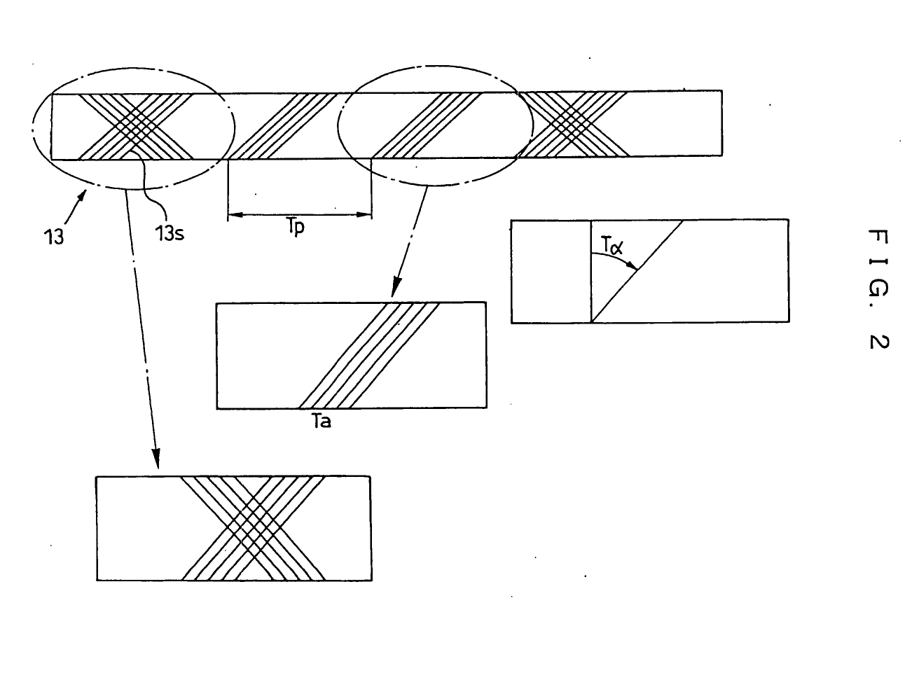

As shown in FIG. 2 which is an enlarged explanatory view, this wire mesh 13 is formed by twisting tin-contained copper alloy wires 13S (each having a wire diameter of 0.047 to 0.06 mm, an elongation percentage of 1%, a breaking force of 700 MPa and an electrical conductivity of 75%) together. This wire mesh is formed by preparing 16 units (number of wirers per carrier) (The number Ta of carriers of each unit is 5, and a braiding angle Ta thereof is 60 to 77 degrees), and then by weaving these at a pitch of 4.8 to 10.3 mm.

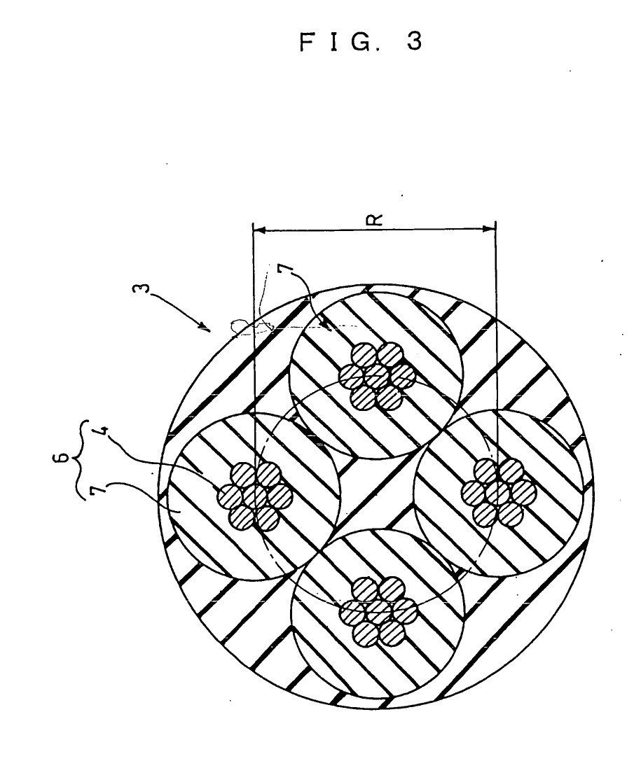

And, this quad-structure wire 3 is formed at a pitch not larger than 30 times larger than a pitch diameter R which is a diameter of a circle interconnecting the centers of the center conductors (the insulated wires 6) forming the quad structure of the signal transmission cable 1, as shown in FIG. 3.

Furthermore, as the insulating sheath 15 covering the whole of the quad-structure wire, there is used an aluminum-bonded polyester tape with a thickness of 0.005 mm to 0.020 mm in which polyester or aluminum is bonded, and this tape is wound around the wire mesh 13 at an overlap rate of about 20% to about 70%.

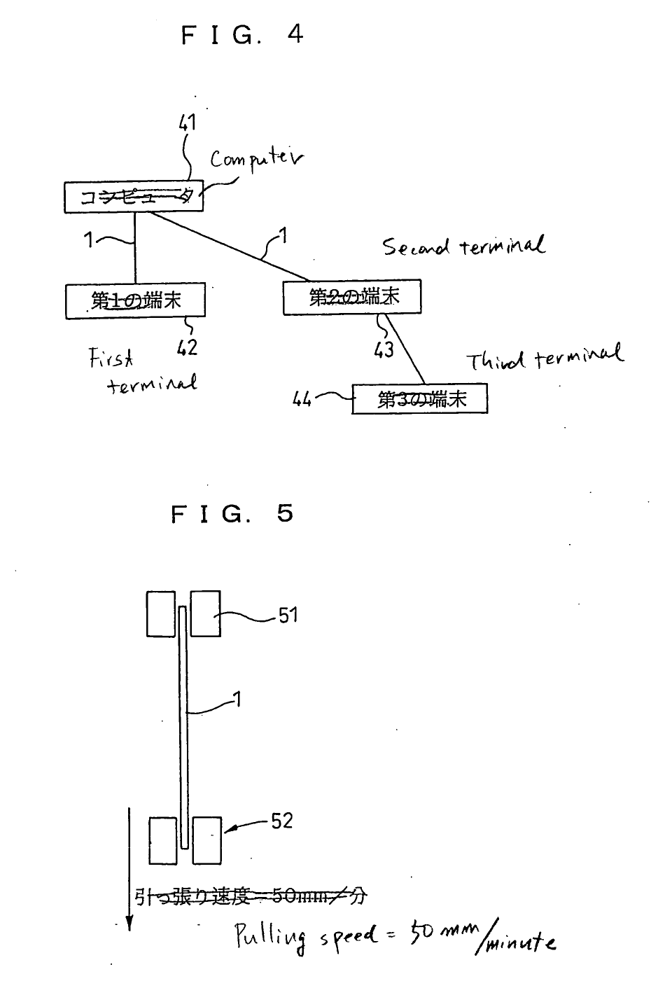

The thus formed signal transmission cable 1 is used to connect a computer. 41 to peripheral terminals thereof, that is, first to third terminals 42, 43 and 44, within a room as shown in FIG. 4.

This signal transmission cable 1 has the very small outer diameter which is not larger than 30% of that of the conventional cable, and sufficiently satisfies the electrical characteristics such as attenuation, and this cable has a high mechanical strength as a whole, and particularly is advantageous in that it has a high tensile strength.

And, when the cable length is not larger than 2.5 m, a broadband performance equal to that of the current products can be secured.

Furthermore, the finish outer diameter of the cable is not larger than 3 mm, and the mechanical breaking force of the wire mesh plus the insulating sheath is not smaller than 100 N.

And, the amount of attenuation of the cable per 2.5 m is not larger than 5.8 dB at 400 MHz.

And, as the wire mesh 13 serving as the sheath, there is used the tin-contained copper alloy wire 13S with the wire diameter of 0.05 mm which is the material having a small degree of elongation and a high tensile strength. Therefore, stresses, acting on the quad-structure wire 3 and hence the center conductors respectively forming the insulated wires 6, can be reduced, and there can be provided the signal transmission cable which has the high mechanical strength although its outer diameter is small.

And, in order to reduce the attenuation amount, it is necessary to increase the pitch of twisting of the four insulated wires 6 (each comprising the insulation-coated center conductor) forming the quad-structure wire 3 and also to increase the laying amount. However, when the pitch is increased, the balance of the four-twist is liable to be lost, and crosstalk characteristics become unstable. And besides, when the pitch of the wire mesh 13 is reduced, the laying amount increases, and therefore there is encountered a problem that stresses are liable to act on the quad-structure wire and hence on the center conductors.

And, this construction eliminates a disadvantage that the insulated wires 6, each comprising the insulation-coated center conductor, is pulled to be broken and cut as a result of elongation of the wire mesh 13.

And besides, the braiding pitch of the wire mesh 13 is so adjusted that this wire mesh will not exceed the elongation of the center conductor forming the insulated wire 6, and therefore there is eliminated a disadvantage that the center conductors are pulled to be broken as a result of elongation of the wire mesh, so that the center conductor wires 4 are cut.

In addition, the material, wire diameter and/or twist pitch of the wire mesh 13 are so selected that this wire mesh will not exceed the elongation of the center conductor wires 4, and therefore there is eliminated a disadvantage that the center conductor wires 4 are pulled to be broken and cut as a result of elongation of the wire mesh 13.

In the above first embodiment, although the tin-contained copper alloy wire is used as the metallic wire forming the wire mesh, the wire are not limited to it, and preferably a material, such as a steel copper wire, having a high electrical conductivity and a high tensile strength, is used.

In this embodiment, although the tin-contained copper alloy wires 13S with the wire diameter of 0.05 mm are used to form the wire mesh, the wire diameter is not limited to this value, and the wire diameter can be suitably changed in the range of between 0.04 mm and 0.12 mm. When the outer diameter is smaller than the wire diameter of 0.04 mm, the tensile strength is small, and the wire mesh itself is liable to be broken. On the other hand, when the wire diameter of the metallic wire (such as the tin-contained copper alloy wire 13S), forming the wire mesh, exceeds 0.12 mm, there are encountered problems that the finish outer shape is thick and that the flexibility is inferior.

More preferably, the wire diameter is in the range of between 0.05 mm and 0.08 mm. In order to maintain the above elongation, it is preferred that the wire diameter be in this range.

Electrical connectors, used in such a signal transmission cable, are classified into two kinds, that is, a 4-pole type and a 6-pole type. A mechanical breaking force, produced when clamping the signal cable to such electrical connectors, is specified in “Amendment 1 of IEEE1394a-1395 Standard”.

According to this standard, it is 49N for the 4-pole type, and it is 98N for the 6-pole type.

Here, the tensile strength is measured by a measuring method shown in FIG. 5, in which one end of the signal transmission cable 1 is fixed by a first chucker 51, and the other end is gripped by a second chucker 52, and the cable is pulled at a pulling speed of 50 nm/minute, and the strength is measured until the cable is broken. Here, the value is measured until any of the wires of the wire mesh is cut, and this is defined as the tensile strength.

In the electrical connector of IEEE1394, usually, a length of several centimeters is cut off from an insulating sheath of a signal cable, and an outer shielding wire mesh is turned back on the insulating sheath, and the connector is clamped to this turned-back portion. Therefore, a force acts on the outer shielding wire mesh and the insulating sheath.

In the embodiment of the signal transmission cable of the invention, unless the mechanical breaking force of the wire mesh and insulating sheath exceeds the specified value of the mechanical breaking force, there will not arises a problem that the center conductors are elongated to thereby worsen the attenuation, and besides in this signal transmission cable, the copper alloy wires, having the mechanical breaking force of not smaller than 400 MPa, are used to form the wire mesh, and therefore this cable can satisfy the specified value of the mechanical breaking force produced when each electrical connector is clamped to the signal cable.

Next, Samples 1 to 4 were prepared as shown in the following Table while changing the dimensions of members, that is, a diameter of a quad-structure wire, a twist pitch of the quad-structure wire, a pitch diameter, a braiding pitch and a braiding angle, and electrical characteristics and mechanical breaking force thereof were measured.

TABLE 1

| | Sample 1 | Sample 2 | Sample 3 | Sample 4 |
|---|---|---|---|---|
| Diameter | 0.37 | 0.35 | 0.32 | 0.36 |
| (mm) of | | | | |
| center | | | | |
| conductor | | | | |
| (insulated | | | | |
| wire) | | | | |
| Twist pitch | 13 | 10 | 12 | 10 |
| (mm) | | | | |
| Pitch | 0.52 | 0.49 | 0.45 | 0.51 |
| Diameter | | | | |
| (mm) | | | | |
| Braiding | 4.8 | 10.3 | 10.3 | 6.9 |
| pitch | | | | |
| (mm) | | | | |
| Braiding | 60 | 76 | 77 | 66 |
| Angle | | | | |
| Attenuation | 4.8 dB/2.5 m | 4.8 dB/2.5 m | 5.3 dB/2.5 m | 5.0 dB/2.5 m |
| amount | | | | |
| (@ 400 MHz) | | | | |
| Breaking | more than | more than | more than | more than |
| strength | 100 N | 100 N | 100 N | 100 N |

All of the above Samples 1 to 4 satisfied the electrical characteristics and mechanical strength, and their outer diameter was between 1.2 mm and 2 mm, and their commercial value was extremely high.

The construction of the wire mesh is not limited to the above embodiment, and can be suitably modified. In the case where the wire mesh has the same number of carriers and the same number of wirers per carrier, the conductor resistance of the wire mesh increases when the pitch is short, so that the attenuation of the signal cable is worsened. And, when the laying amount of the metallic wires of the wire mesh is large, a force is liable to act on the center conductor upon pulling. Therefore, it is desirable that the laying amount is small, and therefore it is necessary to determine the pitch so that braiding angle of the wire mesh can be not smaller than 60 degrees.

Although it is preferred that the metallic wire, used to form the wire mesh, has the tensile breaking force of not smaller than 700 MPa and the electrical conductivity of 75%, the tensile breaking force may be not smaller than 400 Pa, and the electrical conductivity may be not smaller than about 50%.

With this construction, the specified value of the mechanical breaking force, produced when each electrical connector is clamped to the signal cable, can be satisfied.

Although it is preferred that the metallic wire, used to form the wire mesh, has the elongation percentage of 1%, the elongation percentage may be not larger than about 10%. More preferably, it is not larger than 6%, in which case the quad-structure wire is protected by the wire mesh even upon application of a pulling force, and therefore will not be damaged.

And, the wire mesh is constructed such that the braiding angle is not smaller than 60 degrees, and therefore the wire mesh is relatively less liable to be elongated, so that the center conductor wires are hardly damaged.

And, the four insulated wires, forming the quad-structure, has the twist pitch which is not larger than 30 times larger than the pitch diameter, and therefore the crosstalk characteristics can be enhanced, and there can be provided the signal transmission cable of high reliability.

And besides, in the embodiment of the present invention, the center conductor comprises the tinned copper wires, and the metallic wire, forming the wire mesh, is the copper alloy wire, and therefore the two are generally equal in thermal expansion coefficient to each other, and are less liable to undergo stresses due to a temperature change, and therefore there can be provided the more reliable cable.

And, the elongation percentage of the center conductor wires, used here, for a pulling force is larger than the elongation percentage of the metallic wire forming the wire mesh, and therefore the center conductor wires are less liable to undergo stresses and to be cut.

In addition, there is provided a feature that the material, wire diameter and/or twist pitch of the wire mesh are so adjusted that this wire mesh will not exceed the elongation of the quad-structure wire.

This construction eliminates a disadvantage that the quad-structure wire is pulled to be broken and cut as a result of elongation of the wire mesh.

Next, a second embodiment of the present invention will be described.

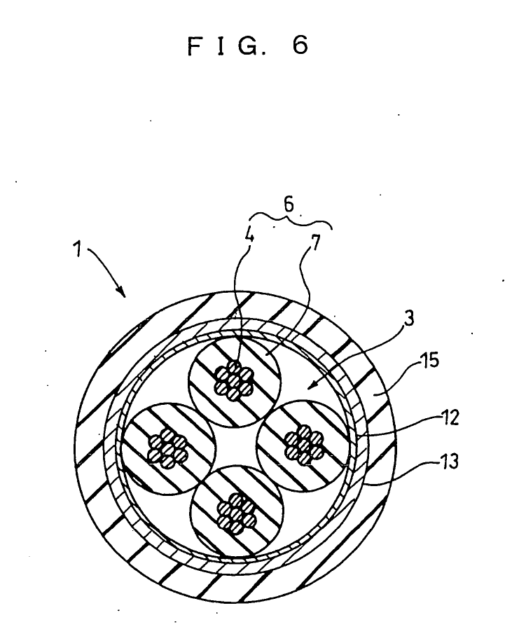

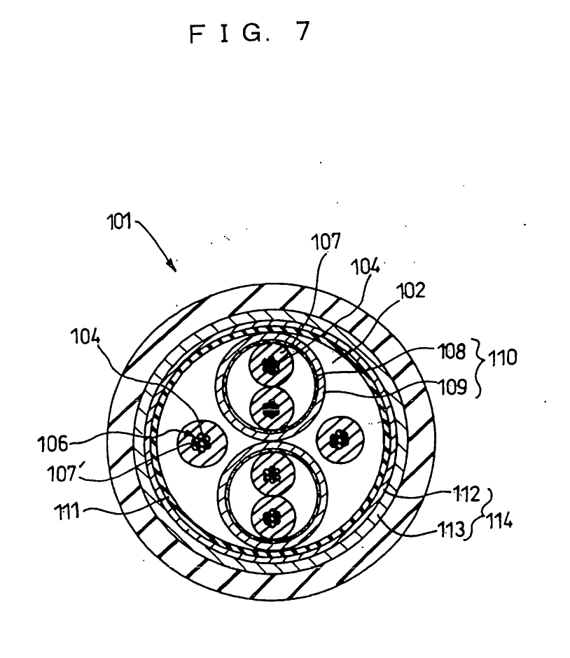

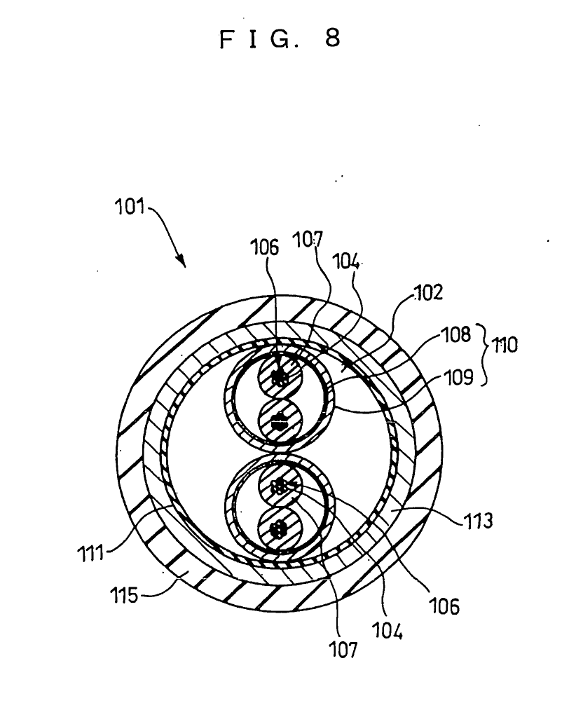

This example is characterized in that a metallic tape 12 is used instead of the insulating tape 11 covering the quad-structure wire 3, as shown in FIG. 6.

The other portions are formed in the same manner as described above for the first embodiment.

This metallic tape 12 comprises an aluminum-bonded polyester tape having a thickness of 0.015 mm, and as in the signal transmission cable of the first embodiment, good electrical characteristics and mechanical characteristics can be maintained with a small outer diameter.

In the case of using the metallic tape, unnecessary radiation (EMI: Electromagnetic Interference) noises can be reduced as compared with the case where the insulating tape is used.

### INDUSTRIAL APPLICABILITY

As described above, the signal transmission cable of the present invention comprises the quad-structure wire, formed by bundling the four insulation-coated insulated wires into the quad-structure, the wire mesh covering the periphery of the quad-structure wire, and the insulating sheath further covering the outer surface of the wire mesh, and the cable is constructed such that its outer diameter is not larger than 3 mm. Therefore, there can be provided the high-speed differential signal cable with the small diameter and the high mechanical strength in which the cable length is in the range of not larger than 2.5 m, and the center conductors and the wire mesh are adjusted, and a control is conducted so as to satisfy the mechanical strength and the attenuation amount, and a broadband performance equal to that of the current products can be secured while greatly reducing the outer diameter.

1. A signal transmission cable comprising:
a quad-structure wire formed by bundling four center conductors, each having an insulating coating, into a quad-structure;
a wire mesh covering a periphery of said quad-structure wire; and
an insulating sheath further covering an outer surface of said wire mesh,
wherein said cable is so constructed that its outer diameter is not larger than 3 mm.

2. A signal transmission cable according to claim 1, characterized in that said signal transmission cable has a length of not larger than 2.5 m, and said cable is so formed that a signal transmission performance (Signal Propagation Performance) and a breaking strength of a connection portion can satisfy Amendment 1 of IEEE1394-1395 Standard.

3. A signal transmission cable according to claim 1, characterized in that a metallic wire, used to form said wire mesh, has a tensile breaking force of not smaller than 400 MPa and an electrical conductivity of not smaller than 50%.

4. A signal transmission cable according to claim 1, characterized in that a metallic wire, used to form said wire mesh, has an elongation percentage of not larger than 10%.

5. A signal transmission cable according to claim 1, characterized in that an angle of braiding of metallic wires, forming said wire mesh, is not smaller than 60 degrees.

6. A signal transmission cable according to claim 1, characterized in that a twist pitch at which said insulation-coated center conductors are twisted together to form said quad-structure wire is not larger than 30 times larger than a pitch diameter.

7. A signal transmission cable according to claim 1, characterized in that said wire mesh is so formed as not to exceed the elongation of said center conductors forming said quad-structure wire.

8. A signal transmission cable according to claim 6, characterized in that said wire mesh is formed of copper alloy wires having a wire diameter of 0.04 to 0.12 mm.

9. A signal transmission cable according to claim 1, characterized in that said signal transmission cable has a connector provided at at least one end thereof, and a strength of said connector is not smaller than 49N for a 4-pole structure, and is not smaller than 98N for a 6-pole structure.

10. A terminal apparatus in a computer system comprising a computer terminal and peripheral devices, characterized in that:
an interface between said computer terminal and said peripheral device or an interface between said peripheral devices is formed by a signal transmission cable as defined in claim 1.

11. A data transmission method characterized in that a signal transmission cable as defined in claim 1 is installed between a computer terminal and a peripheral device or between peripheral devices, and a differential transmission is conducted by the two diagonally-disposed center conductors.
